(19) United States
(12) Patent Application Publication
(10) Pub. No.: US 2014/0220332 A1
(43) Pub. Date: Aug. 7, 2014

(54) NON-STEEL DISTANCE KEEPER IN IMPACT BEAM

(71) Applicants: Hendrik Rommel, Sint-Michiels (BE); Henk Cornelus, Avelgem (BE); Veerle Van Wassenhove, Aarsele (BE)

(72) Inventors: Hendrik Rommel, Sint-Michiels (BE); Henk Cornelus, Avelgem (BE); Veerle Van Wassenhove, Aarsele (BE)

(73) Assignees: NV BEKAERT SA; BASF SE; Voestalpine Polynorm van Niftrik BV

(21) Appl. No.: 14/346,157

(22) PCT Filed: Jun. 21, 2012
(86) PCT No.: PCT/EP2012/061917

§ 371 Date: Mar. 20, 2014

(30) Foreign Application Priority Data
Sep. 21, 2011 (EP) 11182163.3

(51) Int. Cl. B60R 19/18

(52) U.S. Cl. CPC B60R 19/18; B60R 2019/1853; B60R 2019/1813
USPC 428/221; 264/257

(57) ABSTRACT

An impact beam (70) comprises a polymer matrix and a reinforcing structure, the structure further comprises a number of metal reinforcing cords (11) and non-metal elongated binding elements (13) or non-metal coated elongated binding elements arranged between the cords for holding the metal reinforcing cords together. Part of the non-metal elongated binding elements is positioned at the exterior surface of the impact beam in order to keep the metal reinforcing cords away from the surface of the part. The impact beam may also comprise a non-steel distance keeper (66) being positioned at the exterior surface of the impact beam in order to keep the metal reinforcing cords away from the surface of the part. The non-steel distance keeper can either be a non-metal coating on said metal reinforcing cords or non-metal elongated binding elements (55) arranged between the cords for holding the metal reinforcing cords together.

### TECHNICAL FIELD

The present invention relates to impact beams and reinforcements. The invention also relates to methods for providing such impact beams. The invention further relates to the use of impact beams for support of bumpers of vehicles or for impact reinforcing of parts of vehicles.

### BACKGROUND ART

Impact beams are for instance known consisting of a polymer matrix which is reinforced with glass fibres or other polymer fibres. An impact beam may also comprise metal parts, usually on the places where the impact beam receives compression load during impact. In U.S. Pat. No. 5,290,079, the impact beam also comprises a woven wire mesh within the matrix, which is to improve the ductility and flexibility of the impact beam.

Impact beams may be made by pressure moulding or by injection moulding. Due to these manufacturing techniques, these known impact beams have the drawback however that metal parts tend to be present at the exterior surface of the matrix which will result in corrosion risk and too superficial reinforcement. It is also quite possible that the polymer matrix material fails to surround all the metal reinforcing parts because of too exterior placement or much possibility that the metal reinforcing cords are just lying at the exterior surface of the matrix. Thus most part of each metal reinforcing cord or even the whole metal cord will be long exposed to the air, which will take a high risk at corrosion.

For instance, US 2006/013990 discloses an impact beam with a semifinished sheet comprising a polymer matrix and a textile product comprising metal cords which are preferably stitched to the separate textile layer. Such an impact beam reduces or solves the problem of migration of the cords during pressing. The known impact beam does however have a few drawbacks. As the metal cords are bond to the layer of non-metallic fibres by means of stitches, it would involve one or more steps in the production process as compared to the only one manufacture step of a common textile product. Besides, most part of the metal cords except the part with sewn or knitted stitches are pushed to the exterior surface of the matrix during the injection molding, thus the exposed area take a rather high risk at corrosion.

### DISCLOSURE OF INVENTION

It is an object of the invention to provide an improved impact beam wherein at least one of the above stated prior art drawbacks is obviated.

It is also an object of the present invention to provide a reinforcing structure for impact beam that keeps the metal reinforcing cords away from the surface of the impact beam.

It is still another object of the present invention to further provide a reinforcing structure for impact beam with a non-steel distance keeper at the exterior surface of the impact beam.

It is a further object of the invention to provide a method for manufacturing an impact beam provided with such a reinforcing structure.

According to the first aspect of the invention there is provided an impact beam. The impact beam comprises a polymer matrix and a reinforcing structure. The structure comprises a number of metal reinforcing cords and non-metal elongated binding elements or non-metal coated elongated binding elements arranged between the cords for holding the metal reinforcing cords together.

The metal cords and the non-metal elongated binding elements or non-metal coated elongated binding elements are forming a hybrid structure, e.g. a hybrid fabric, where the term “hybrid” refers to the combination of metal and non-metal elements. Parts of the non-metal elongated binding elements or non-metal coated elongated binding elements are positioned at the exterior surface of the impact beam in order to keep the metal reinforcing cords away from the surface of the part.

So the non-metal elongated binding elements or non-metal coated elongated binding elements have a double function. The non-metal elongated binding elements or non-metal coated elongated binding elements may not only function as a binding material for holding the metal reinforcing cords together but also a distance keeper between the metal reinforcing cords and the exterior surface of the matrix with its thickness keeps the metal reinforcing cords away from the exterior surface of the part in order to make sure the polymer matrix material can surround the metal reinforcing cords, which will definitely avoid the high corrosion risk and too superficial reinforcement of the impact beam.

The clue of this distance keeper is to have the metal reinforcing cords well embedded in the matrix and not have them on the exterior surface to improve the performance of the matrix and avoid pulling out of the cords through a too thin layer of matrix, which will give a good corrosion protection at the same time. For matrix parts with very limited wall thickness the hybrid structure can be ‘tuned’ so that the reinforcing metal cords are symmetrical integrated between the ‘distance keepers’ and when the hybrid fabric has a thickness similar to the part thickness we can position the steel elements very central in thickness of the matrix; this improving the properties in compression.

Further, an impact beam as subject of the invention comprises a polymer matrix. This polymer matrix is preferably a thermoplastic polymer material.

More preferred, the thermoplastic polymer material is selected from the group consisting of polypropylene, polyethylene, polyamide, polyethylene terephtalate, polybutylene terephtalate, polycarbonate, polyphenylene oxide as well as blends of these materials, or thermoplastic elastomers, e.g. polyamide- or polyolefin-based thermoplastic elastomers such as polyester amides, polyether ester amides, polycarbonate-ester amides or polyether-block-amides.

The polymer matrix may further comprise glass- or C-fibers, polymeric fibers and/or mineral fillers to reinforce the polymer matrix. Fibers can either be random, unidirectional, woven; stitched, chopped, or a combination of those.

The material type for the non-metal elongated binding elements can be compatible with the matrix. The non-metal element can be a yarn or even a monofilament. E.g. glass yarn that is dipped to obtain adhesion with the matrix, or a yarn that is made out of the same polymer as the matrix and thus either adhering well or melting a bit on the surface during injection molding and thus obtaining good anchoring. E.g. a monofilament out of the earlier mentioned polymers or from a material type that is compatible with the matrix and not disturbing too much the matrix, e.g. Polyester.

And the material type for such non-metal coated elongated binding elements in this invention can be plastic coated steel wires, plastic coated metal cords, etc. The plastic can be a suitable polymer that is extruded around the metal cords or the steel wires, etc. Further, the polymer can be made out of the same polymer as the matrix or from a material type that is compatible with the matrix and not disturbing too much the matrix, e.g. Polyester.

An impact beam is characterized by a direction in which impact forces are expected to work on the impact beam. This direction is hereafter referred to as “impact direction”. Impact beams are characterized by an impact plane, being the plane perpendicular to the direction of impact. One dimension of this plane is usually relatively large and is hereafter referred to as length of the impact beam. The second dimension of the impact beam in this impact plane is usually much smaller than the length. This direction is hereafter referred to as height of the impact beam. The dimension of the impact beam, perpendicular to impact plane is referred to as thickness of the impact beam.

The metal cords of an impact beam as subject of the invention may be provided in one direction or two directions.

Preferably, the metal cords are provided in the warp direction which is parallel to the length of the impact beam. A number of metal reinforcing cords parallel to each other are provided with non-metal elongated binding elements or non-metal coated elongated binding elements arranged between the cords for holding the metal reinforcing cords together. Each non-metal element or non-metal coated elongated binding element is interwoven, braided or knitted with the metal cords to provide a hybrid fabric before molding of the impact beam as subject of the invention. Then during molding of the impact beam, the hybrid fabric is provided with a curved shape. The curved surface “draped” around the plane defined by the length and height, and bended in a direction defined by the length and thickness of the impact beam. The curvature in thickness direction preferably extends to the side of the impact beam on which the impact force is to be expected to work. It can be seen obviously in the final product that parts of the non-metal elongated binding elements or non-metal coated elongated binding elements are positioned at the exterior surface of the impact beam and the metal reinforcing cords are away from the surface of the impact beam. Thus, the polymer matrix material is surrounding the metal reinforcing cords, which are all fully embedded in the matrix of the impact beam.

Preferably however, the metal cords are provided in two directions where warp and weft are essentially perpendicular towards each other.

The wording “essentially perpendicular” is to be understood in a sense that for each pair of metal cords with one metal cord in the warp direction and the other from the weft, said cords being contacted with each other, the angle between warp and weft is about 90 degrees, e.g. 89 degrees or 92 degrees or even 95 degrees.

Most preferably the metal cords are steel cords to be used to provide the impact beam as subject of the invention. A steel cord according to the invention was built as follows. Starting product is a steel wire rod. This steel wire rod has following steel composition: A minimum carbon content of 0.65%, a manganese content ranging from 0.40% to 0.70%, a silicon content ranging from 0.15% to 0.30%, a maximum sulphur content of 0.03%, a maximum phosphorus content of 0.30%, all percentages being percentages by weight. A typical steel cord composition for high-tensile steel cord has a minimum carbon content of around 0.80 weight %, e.g. 0.78-0.82 weight %.

The steel rod is drawn in a number of consecutive steps until the required final diameter. In this example, the round diameter for the core is 0.265 mm and 0.245 mm for the steel filaments in the layer. The drawing steps may be interrupted by one or more heat treatment steps such as patenting.

As explained in another co-pending application of applicant, a too good anchorage between the metal cords and the matrix is to be avoided and so is a too good chemical bond between the metal cords and the matrix. However, a good chemical bond between the non-metal elongated binding elements or non-metal coated elongated binding elements and the matrix has proved to be beneficial.

In order to assure a good adhesion between the non-metal elongated binding elements or non-metal coated elongated binding elements and the polymer material, an adhesion promoter can be applied on the non-metal elongated binding elements or non-metal coated elongated binding elements. Possible adhesion promoters are bi-functional coupling agents such as silane compounds. One functional group of these coupling agents is responsible for the binding with the non-metal elongated binding elements or non-metal coated elongated binding elements, the other functional group reacts with the polymer. That's to say, the non-metal elongated binding elements or non-metal coated elongated binding elements is having a chemical bond with said polymer matrix.

After an optional cleaning operation, the non-metal elongated binding element or non-metal coated elongated binding element is then coated with a primer selected from organo functional silanes, organo functional titanates and organo functional zirconates which are known in the art for said purpose. Preferably, but not exclusively, the organo functional silane primers are selected from the compounds of the following formula:

Y—(CH2)n-SiX3

wherein:
Y represents an organo functional group selected from —NH2, CH2=CH—, CH2=C(CH3)COO—, 2,3-epoxypropoxy, HS— and, Cl—
X represents a silicon functional group selected from —OR, —OC(═O)R′, —Cl wherein R and R′ are independently selected from C1 to C4 alkyl, preferably —CH3, and —C2H5; and
n is an integer between 0 and 10, preferably from 0 to 10 and most preferably from 0 to 3

The organo functional silanes described above are commercially available products. More details about these coupling agents can be found in the PCT application WO-A-9920682. Unless specified, all kinds of material made from the polymer matrix underneath mentioned are mixed with one kind of possible adhesion promoters; non-metal elongated binding elements or non-metal coated elongated binding elements mentioned underneath are coated with a layer of another possible adhesion promoters. Much possibility that the two kinds of possible adhesion promoters are bifunctional coupling agents.

A method for providing an impact beam as subject of the invention, comprises the steps of
providing metal cords and non-metal elongated binding elements or non-metal coated elongated binding elements;
providing a hybrid fabric as a reinforcing structure;
bringing the hybrid fabric in an injection mold and positioning the hybrid fabric in the mold;
injecting polymer material to said hybrid fabric, providing an impact beam;
cooling the impact beam.

According to another aspect of this invention, an impact beam comprises a polymer matrix and a reinforcing structure, the reinforcing structure comprising a number of metal reinforcing cords, and impact beam further comprises a non-steel distance keeper being positioned at the exterior surface of the impact beam in order tokeep the metal reinforcing cords away from the surface of the part. The non-steel distance keeper can either be a non-metal coating on the metal reinforcing cords or non-metal elongated binding elements or non-metal coated elongated binding elements arranged between the cords for holding the metal reinforcing cords together.

More preferably, the non-steel distance keeper on some locations in the impact beam is the only element at the exterior surface of the impact beam. E.g. an extruded polymer layer wherein polymer is compatible with the matrix is working as a distance keeper when for instance applied directly on the cord or on some of the cords out of the construction. These distance keepers can be local due to fabric construction, or can be continuous, e.g. coating or film layer.

According to the present invention, the terms “impact beam” refer to light weight structural parts of a car where impact resistance is of relevance. An ‘impact beam’ can be a front bumper, a rear bumper, one or two beams in the front door, one or two beams in the rear door, the A-pillar or A-post, the B-pillar or B-post, the C-pillar or C-post and the D-pillar or D-post.

### BRIEF DESCRIPTION OF FIGURES IN THE DRAWINGS

The invention will now be described into more detail with reference to the accompanying drawings wherein

FIGS. 1 to 5 shows different embodiments of reinforcing structures comprising metal reinforcing cords and non-steel distance keepers;

FIG. 6 shows a coated metal cord;

FIG. 7 being schematically a front view of an impact beam as subject of the invention;

FIG. 8a shows schematically the use of an impact beam as subject of the invention to support a vehicle bumper (before impacting).

FIG. 8b shows schematically the use of an impact beam as subject of the invention to support a vehicle bumper (after impacting).

### MODE(S) FOR CARRYING OUT THE INVENTION

A fabric can be understood as a woven, knitted or braided structure. Different embodiments of a fabric according to the present invention can be considered.

Examples of knitted structures:

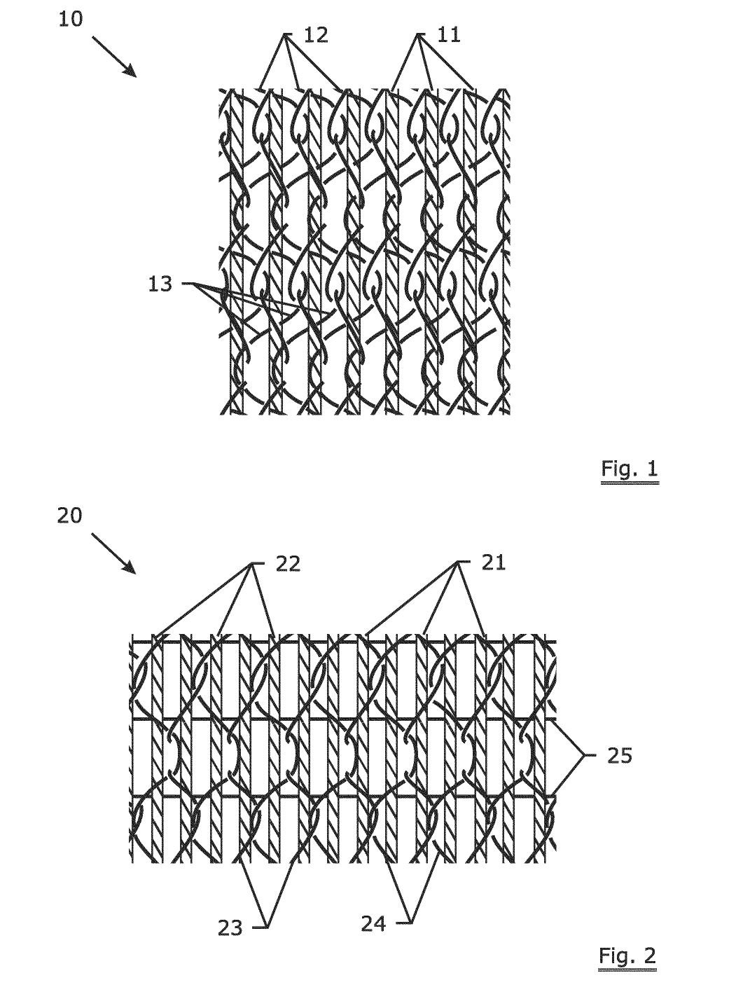

Steel cords are provided in warp direction on a warp knitting machine. A first set of non-metallic warp threads is provided to make stitches and an additional second set of non-metallic threads is provided that is laid in over a number of needles during warp knitting. Additionally, there may be steel cords laid in over the full width of the fabric. The first set of non-metallic warp threads are making stitches, e.g. open or closed pillar stitches, in order to connect the different sets of threads and steel cords into a fabric. FIGS. 1 to 3 shows different embodiments of knitted reinforcing structures.

A fabric 10 as shown in FIG. 1 is manufactured as follows: a set of steel cords 11 is provided in warp direction and is forming a straight warp. A first set of non-metal warp threads 12 is provided with the same warp density as the steel cord warp. The first set of non-metal warp threads 12 can be polyester multifilament, e.g. a twisted 110 tex yarn. As an example, the first set of non-metal warp threads 12 makes an open or closed pillar stitch, thereby enclosing the steel cords 11 in warp direction. A second set of non-metal warp threads 13 makes an inlay over a number of needles, thereby connecting the different pillars (formed by the steel cords in the warp and the threads of the first set of non-metal threads) and hence building the fabric. The second set of non-metal threads can e.g. be a twisted yarn or a monofilament. An example of an inlay pattern is over three cords.

In another embodiment, a fabric 20 as shown in FIG. 2 is made as follows: two sets of steel cord warp sets 21 and 22 are provided, wherein the steel cords of both sets are alternating over the width of the fabric. Corresponding with the first of the two sets (with set 21) of steel cord warps, is a first set of non-metal warp threads 23. The first set of non-metal warp thread can e.g. be a twisted multifilament yarn of 220 tex, making a closed or an open pillar stitch, thereby enclosing one of the two sets of steel cord warps. The second set of steel cords 22 in the warp is a straight warp. A second set of non-metal threads 24 (e.g. a twisted multifilament yarn of 220 tex) is making a short inlay. A third set of non-metal yarns 25 is laid in, every revolution of the machine, over the full width of the fabric. This way, the second set of steel cords 22 is connected into the fabric as it is enclosed between the second and third set of non-metal threads.

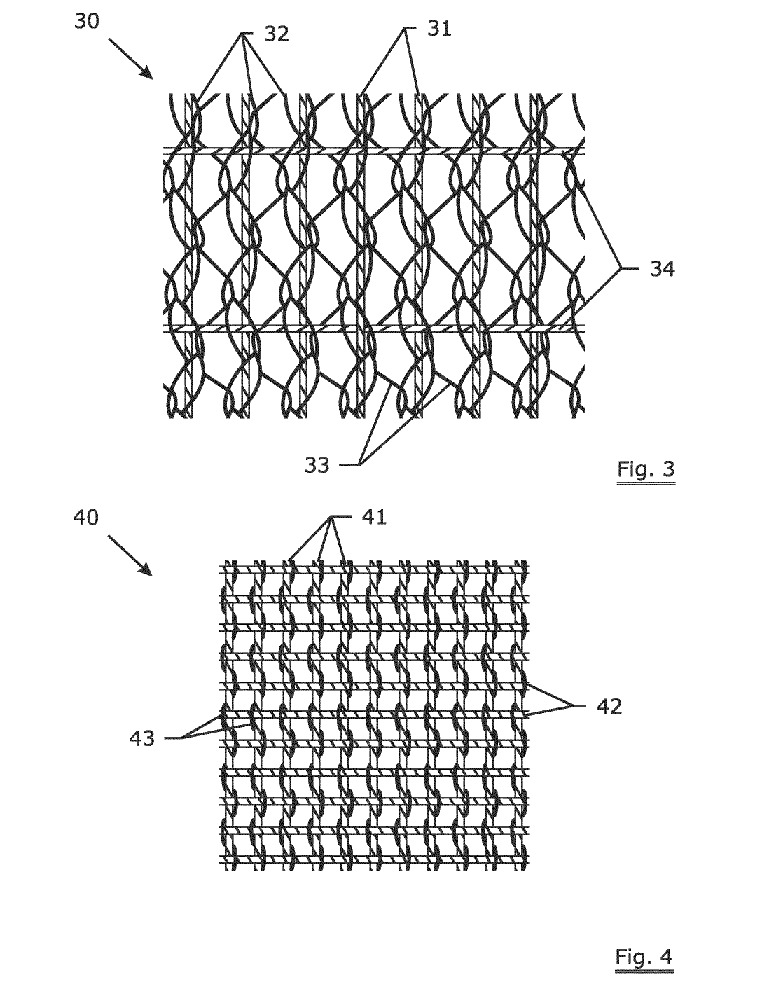

In yet another embodiment, a fabric 30 as shown in FIG. 3 is produced as follows: a set of steel cords 31 is provided in warp direction and forming a straight warp. A first set of non-metal warp threads 32 is provided with the same warp density as the steel cord warp. The first set of non-metal warp threads can be polyester multifilament, e.g. a twisted 220 tex yarn. As an example, the first set of non-metal warp threads make an open or closed pillar stitch, thereby enclosing the steel cords in warp direction. A second set of non-metal warp threads 33 makes an inlay over a number of needles, thereby connecting the different pillars (formed by the steel cords in the warp and the threads of the first set of non-metal threads) and hence building the fabric. The second set of non-metal threads can e.g. be a twisted multifilament polyester yarn of 220 tex. Every forth revolution of the warp knitting machine, a steel cord 34 is laid in over the full width of the machine and bound into the fabric by means of the pillar stitches formed by the first set of non-metal warp threads.

Besides warp knitting, leno weaving can be used to produce a fabric according to the invention. A leno woven fabric 40 is shown in FIG. 4. Steel cords 41 are provided in warp direction and steel cords 42 are provided in weft direction (across the warp). The steel cords in weft and in warp direction are connected to each other by means of an additional set of non-metal warp threads 43. The additional set of non-metal warp threads 43 is forming a leno weave, being twisted around the steel cords 41 in warp direction.

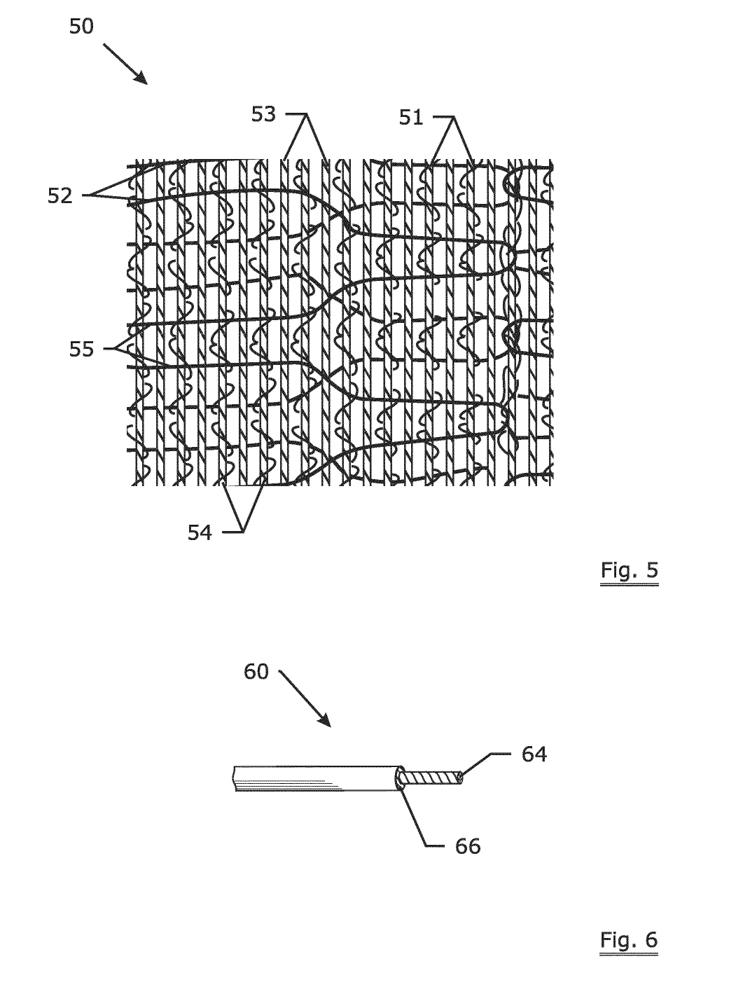

FIG. 5 shows another embodiment of the invention. Fabric 50 is made on a warp knitting machine. A first set of non-metal yarns is a twisted polyester multifilament 51 of 220 tex. This set of twisted yarns 51 are making an open pillar stitch. The stitch density is 2 stitches per cm.

A second set of non-metal yarns is a polyester multifilament 52 of 220 tex. The multifilaments 52 are being laid in the warp knitted fabric.

A third set are steel cords 53. An example of steel cord that can be used is SC 3×0.265+9×0.245 HT. The steel cords 53 are forming a standing warp in the fabric.

A fourth set are steel cords 54. An example of a steel cord that can be used is SC 3×0.265+9×0.245 HT. The steel cords 54 are forming a standing warp and are enclosed by the open pillar stiches formed by the set of twisted polyester multifilament yarns.

A fifth set are non-metal yarns, eg twisted polyester multifilaments 55 of 220 tex. The multifilaments 55 are being laid in the warp knitted. The steel cords 53 are bonded in the fabric between the non-metal elements or non-metal coated elements, here the multifilament sets 52 and 55.

FIG. 6 shows a coated metal cord 60 as an element of a reinforcing structure wherein the coating layer 66 works as a distance keeper according to another aspect of this invention. 64 refers to the metal cord itself. The coating of a metal cord can be applied by any conventional means. A possible coating method is extrusion. For the purpose of the invention a coated metal cord has to be understood as an element substantially surround by at least one layer of a thermoplastic material. This means that this can also be realised by wrapping thermoplastic threads or filaments around a metal cord.

It is to be understood that the invention is not limited to the reinforcing structures comprising distance keepers as described above, but that it may also be applied to structures with only one element at the exterior surface of the impact beam, which keeps the metal reinforcing cords away from the surface of the part.

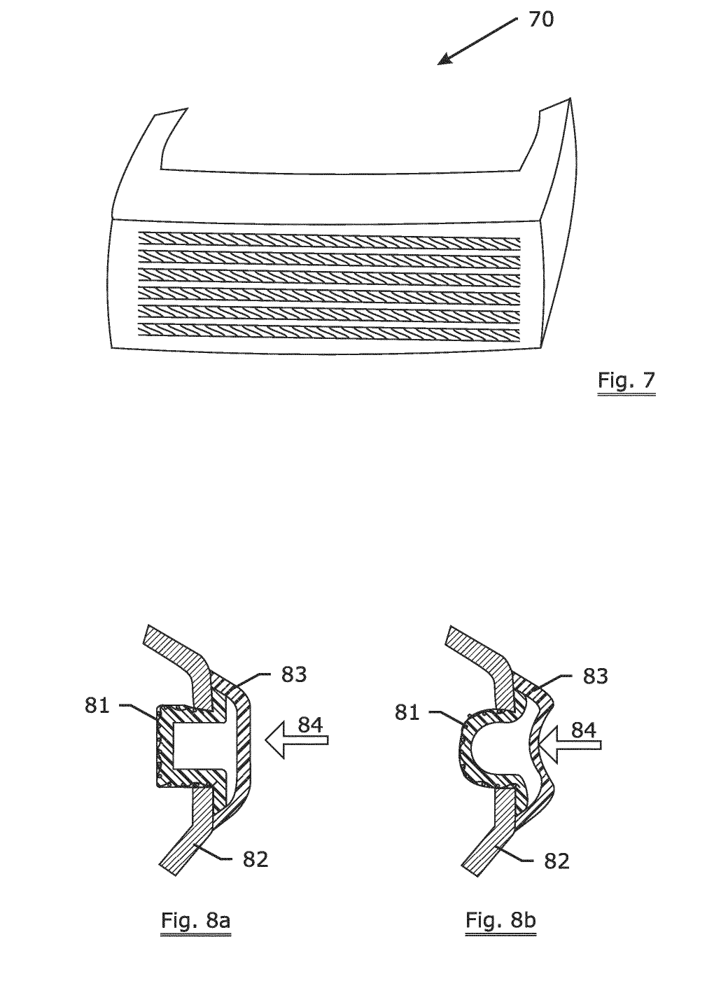

Turning now to a method to provide an impact beam being subject of the invention. A reinforcing structure is made as shown in any embodiments in FIGS. 1 to 5. When the thus formed hybrid fabric is placed at the opposite side of the injection molding by means of magnets which are integrated in one of the two tool parts and then thermoplastic material is injected. The thermoplastic material will enclose the hybrid fabric but also upon the closing of the mould, the hybrid fabric will bend into a curved shape because of a large closing pressure. The curved surface “draped” around the plane defined by the length and height, and bended in a direction defined by the length and thickness of the impact beam. The curvature in thickness direction preferably extends to the side of the impact beam on which the impact force is to be expected to work. The front view of an impact beam 70 as subject of the invention can be schematically shown as FIG. 7 or beam 81 in FIG. 8a.

After this molding, the mold and the shaped impact beam are cooled to a temperature for which the polymer material is solidified. The impact beam may then be taken out of the mold and is ready for further processing, such as quality control or provision of additional openings.

An impact beam is so provided, which may be used as support for soft bumpers of vehicles in FIG. 8a.

An impact beam 81 is connected to peripheral elements 82 of the vehicle coachwork. A soft bumper element 83 may be provided covering the impact beam 81. When the vehicle strikes an object, an impact force with a direction 84 will apply in as indicated in FIG. 8b.

As shown in FIG. 8b, the polymer material of the impact beam 81 is surrounding all the metal reinforcing cords, which will absorb the impact energy to a large extent. Besides, as the metal cord is coming loose from the matrix within the matrix being put under high stress as described in the above-mentioned other co-pending application, together with the characteristic—the polymer material of the impact beam will adhere to the non-metal element of the hybrid fabric to a large extent, this to avoid that particles of the polymer material will be projected further towards the parts of the vehicles which are located behind the impact beam.

1. An impact beam comprising a polymer matrix and a reinforcing structure, said reinforcing structure comprising a number of metal reinforcing cords and non-metal elongated binding elements or non-metal coated elongated binding elements arranged between the cords for holding the metal reinforcing cords together, wherein that part of the non-metal elongated binding elements is positioned at the exterior surface of the impact beam in order to keep the metal reinforcing cords away from the surface of the part.

2. An impact beam as claimed in claim 1, wherein said polymer matrix comprises thermoplastic polymer material.

3. An impact beam as claimed in claim 2, wherein said thermoplastic polymer material is selected from the group consisting of thermoplastic elastomers, polypropylene, polyethylene, polyamide, polyethylene terephtalate, polybutylene terephtalate, polycarbonate, polyphenylene oxide, and blends of polypropylene, polyethylene, polyamide, polyethylene terephtalate, polybutylene terephtalate, polycarbonate, polyphenylene oxide.

4. An impact beam as claimed in claim 3, wherein said thermoplastic polymer material is a polypropylene- or polyamide-based thermoplastic elastomer.

5. An impact beam as claimed in claim 1, wherein the material type for said non-metal elongated binding elements is compatible with the matrix.

6. An impact beam as claimed in claim 1, wherein said non-metal elongated binding element is a yarn.

7. An impact beam as claimed in claim 1, wherein said non-metal elongated binding element is a monofilament.

8. An impact beam as claimed in claim 1, wherein said metal reinforcing cords are arranged in one or two directions.

9. An impact beam as claimed in claim 8, wherein said metal cords are arranged in only one direction, said direction being warp.

10. An impact beam as claimed in claim 8, wherein said metal cords provided in two directions where warp and weft are essentially perpendicular towards each other.

11. An impact beam as claimed in claim 1, wherein said metal reinforcing cords are steel cords.

12. An impact beam as claimed in claim wherein said non-metal elongated binding elements have a chemical bond with said polymer matrix.

13. A method for providing an impact beam, said method comprising the steps of
providing metal cords and non-metal elongated binding elements;
providing a hybrid fabric;
bringing the hybrid fabric in an injection mold and positioning the hybrid fabric in the mold;
injecting polymer material to said hybrid fabric, providing an impact beam;
cooling the impact beam.

14. Use of an impact beam as in claim 1 for bumpers of vehicles or to improve the impact resistance of vehicle's coachwork.

15. An impact beam comprising a polymer matrix and a reinforcing structure, said reinforcing structure comprising a number of metal reinforcing cords, wherein said impact beam further comprises a non-steel distance keeper being positioned at the exterior surface of the impact beam in order to keep the metal reinforcing cords away from the surface of the part to surround said metal reinforcing cords, said non-steel distance keeper being either a non-metal coating on said metal reinforcing cords or non-metal elongated binding elements or non-metal coated elongated binding elements arranged between the cords for holding the metal reinforcing cords together.

16. An impact beam according to claim 15, wherein said non-steel distance keeper on some locations in said beam is the only element at the exterior surface of said impact beam.
